(19) United States
(12) Patent Application Publication
(10) Pub. No.: US 2013/0054543 A1
(43) Pub. Date: Feb. 28, 2013

(54) Inverted Order Encoding in Lossless Compresssion

(71) Applicant: Larry K. Brown, Bellingham, MA (US)

(72) Inventor: Larry K. Brown, Bellingham, MA (US)

(73) Assignee: INVENSYS SYSTEMS, INC., Foxboro, MA (US)

(21) Appl. No.: 13/215,987

(22) Filed: Aug. 23, 2011

(51) Int. Cl. G06F 17/30

(52) U.S. Cl. 707/693; 707/E17.002

(57) ABSTRACT

A method of compressing an electronic file is provided. The method comprises reading a first electronic file in reverse order sequence from bottom to top, while reading the first file, identifying patterns in a content of the first file and while reading the first file, building a dictionary comprising a plurality of entries, each entry defining an association of a code to one of the patterns identified in the content of the first file. The method further comprises, while reading the first file, building a second electronic file that is a compressed version of the first file, wherein the second electronic file comprises a compressed content portion and a dictionary portion, wherein the compressed content portion comprises codes from the dictionary and wherein the dictionary portion comprises the dictionary.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Data and computer execution instructions may be stored in electronic files that may be conceptualized as an ordered sequence of bytes or other unit of binary values. Electronic files may be referred to as computer files or simply files in some contexts. With reference to the conceptualization of files as an ordered sequence of bytes, files may be considered to have a top or beginning location, a first byte in the file, and a bottom or end location, a last byte in the file. Electronic files may be compressed to reduce the size of the files using various algorithms to reduce the memory space needed to store the files and/or to transmit the files. For example, large files may be compressed before attaching to an email for transmitting over the Internet. At the receiving end, the compressed files may then be uncompressed using a decompression algorithm that is complementary to the compression algorithm that was employed to compress the files. Compression algorithms may be categorized as lossless or lossy. A lossless compression algorithm allows the reconstruction of the original file from the compressed file with no loss of information. A lossy compression algorithm, by contrast, permits reconstruction of only an approximation of the original file from the compressed file. Typically lossy compression algorithms tradeoff approximate reconstruction in exchange for a higher degree of compression. In some applications approximate reconstruction may be acceptable, for example when sharing photographs among friends over the Internet. In other applications, however, lossy compression may be unacceptable, for example when compressing text documents or firmware files.

U.S. Application Publication 20080219575 by Wittenstein describes a method and apparatus for lossless compression and decompression of images. Wittenstein discloses processing a subject image comprised as an array of pixels, each pixel defined by a digital red value, a digital green value, and a digital blue value. The digital image and/or digital file is scanned to compress the data by processing with one or more filters. For example, the digital image is scanned to compress by processing first with a temporal filter, next processing the output of the temporal filter with a spatial filter, next processing the output of the spatial filter with a spectral filter to produce compressed data or a compressed file. The compressed data and/or compressed file is decompressed by reversing the compression steps. The order of the filtering steps during compression may be shuffled, but then the order of the defiltering steps during decompression must correspond with the order of filtering during compression. Thus, Wittenstein discloses a symmetrical compression-decompression cycle that employs inverse filters in an order reversed from the corresponding filters.

U.S. Pat. No. 5,748,786 by Zandi describes a method and apparatus for lossless compression and decompression of data using reversible embedded wavelets. Zandi discloses processing data decomposing the data using reversible wavelets: for example, representing the data stream as a sequence of wavelet transform coefficients. This sequence of wavelet transform coefficients is encoded to form the compressed data stream. To decompress, the compressed data stream is processed in reversed order relative to the compression process: the compressed data stream is decoded. The decoded stream is inverse wavelet transformed. Thus, Zandi discloses a symmetrical compression-decompression cycle that employs inverse wavelet transforms in an order reversed from the corresponding steps of transforming and coding.

### SUMMARY

In an embodiment, a method of compressing an electronic file is disclosed. The method comprises reading a first electronic file in reverse order sequence from bottom to top, while reading the first file, identifying patterns in a content of the first file and while reading the first file, building a dictionary comprising a plurality of entries, each entry defining an association of a code to one of the patterns identified in the content of the first file. The method further comprises, while reading the first file, building a second electronic file that is a compressed version of the first file, wherein the second electronic file comprises a compressed content portion and a dictionary portion, wherein the compressed content portion comprises codes from the dictionary and wherein the dictionary portion comprises the dictionary.

In an embodiment, a method of uncompressing an electronic file is disclosed. The method comprises reading a first electronic file and, while reading the first file, writing a second file that is a decompressed version of the first file. The first electronic file comprises a losslessly compressed content portion and a dictionary portion. The dictionary portion comprises a plurality of dictionary entries, each entry defining an association of a code to a symbol pattern. A content of the second file is in reversed order with respect to the lossless compressed content portion of the first file.

In an embodiment, a method of transmitting a firmware file is disclosed. The method comprises reading a firmware file in reverse order and, while reading the firmware file, compressing the firmware file to create a compressed file using a lossless compression algorithm. The compression algorithm comprises identifying patterns in a content of the firmware file and building a dictionary comprising a plurality of entries, each entry defining an association of a code to one of the identified patterns. The method further comprises transmitting the compressed file to one of a process control device or a portable communication device.

In an embodiment, a computer program product for compressing an electronic file is disclosed. The computer program product comprises a computer readable storage medium having a computer usable program code embodied therein, the computer usable program code to read the electronic file in reverse order and, while reading the electronic file, to compress the electronic file to create a compressed electronic file using a lossless compression algorithm, wherein the compression algorithm comprises identifying patterns in a content of the electronic file and building a dictionary comprising a plurality of entries, each entry defining an association of a code to one of the identified patterns.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is an illustration of a system according to an embodiment of the disclosure.

FIG. 2 is an illustration of an electronic file compression process according to an embodiment of the disclosure.

FIG. 3 is an illustration of another electronic file compression process according to an embodiment of the disclosure.

FIG. 4 is an illustration of an electronic file decompression process according to an embodiment of the disclosure.

FIG. 5 is an illustration of another electronic file decompression process according to an embodiment of the disclosure.

FIG. 6 is an illustration of a method according to an embodiment of the disclosure.

FIG. 7 is an illustration of an exemplary process for compressing an electronic file according to an embodiment of the disclosure.

FIG. 8 is an illustration of a method according to an embodiment of the disclosure.

FIG. 9 is an illustration of a method according to an embodiment of the disclosure.

FIG. 10 illustrates an exemplary computer system suitable for implementing an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

Some lossless compression algorithms scan the original file from beginning to end and compress as the scan progresses. These lossless compression algorithms may build a dictionary of byte patterns that are identified while scanning and substitute a short code in the compressed file in the place of the byte pattern. The replacement of lengthy byte patterns by short codes provide the desired compression. When decompressing the compressed file, the codes are replaced with either the corresponding byte (in the case that the subject code is not present in the compression dictionary or is not associated with a byte pattern) or the complete byte pattern copied from the dictionary. In some lossless compression algorithms the compression dictionary is of fixed length, and once the allocated number of byte pattern entries have been added to the compression dictionary, no further byte patterns are allowed to be defined. If the byte patterns are evenly distributed throughout the original file, this characteristic building of the byte pattern dictionary is not problematic. In some kinds of files, however, byte patterns are not evenly distributed throughout the files. For example, firmware files typically have a large number of repeating patterns of bytes at the bottom of the firmware files, for example default values associated with unused memory. Because the compression dictionary may be built and fixed before scanning to the bottom of the firmware files where the largest number of repeating byte patterns are located, no compression may be achieved while scanning this portion of the file where the greatest opportunity for compression may in fact exist.

A method for performing lossless file compression based on scanning the ordered sequence of bytes of an original electronic file in reverse order is taught herein. When the compression scan begins, by reading from the bottom of the uncompressed file rather than from the top of the uncompressed file, the compression dictionary is empty. As byte patterns are identified during the reverse scanning, the compression dictionary is built and used to create the compressed file. It is contemplated that a variety of methods may be employed both to write the compressed file as well as to decompress the compressed file.

For example, in an embodiment, the compressed file may be written from a beginning position in the compressed file to an end position in the compressed file, which results in a reversed order compressed file. In this case, information at the end of the original file will be represented in compressed form towards the beginning of the compressed file and information at the beginning of the original file will be represented in compressed form towards the end of the compressed file. When decompressing this compressed file, the decompression algorithm may scan the compressed file from a top of the compressed file and progressing sequentially to a bottom of the compressed file and writing the reconstructed file from a bottom of the reconstructed file and progressing sequentially to a top of the compressed file. Alternatively, the decompression algorithm may scan the compressed file beginning at the bottom of the compressed file and progressing sequentially to the top of the compressed file and writing the reconstructed file from the top and progressing sequentially to the bottom of the reconstructed file.

In another embodiment, the compressed file may be written from a bottom of the compressed file to a top of the compressed file. In this case, information at the top of the original file will be represented in compressed form towards the top of the compressed file and information at the bottom of the original file will be represented in compressed form towards the bottom of the compressed file. When decompressing this compressed file, the compressed file may be scanned from top to bottom and the reconstructed file may be written from top to bottom.

As distinguished from the Zandi patent and the Wittenstein patent application discussed briefly in the background, the present disclosure teaches scanning the data that is being compressed in a reversed order. The compression approach taught by the present disclosure takes advantage of a presumed character of the subject data: the subject data is expected to have more opportunities for efficient compression—often repeated lengthy patterns of data—at the end of the subject data than at the beginning of the subject data. In Zandi and Wittenstein the subject data is not projected or presumed to have any such lop-sided distribution of compression opportunities, and they do not suggest or hint at adapting the order of scanning the data according to this insight into the character of the data to be compressed. Partly this is because Zandi and Wittenstein are general purpose compression methods and partly this may be because Zandi and Wittenstein do not appear to rely on a dictionary. as used for example, in LZW compression.

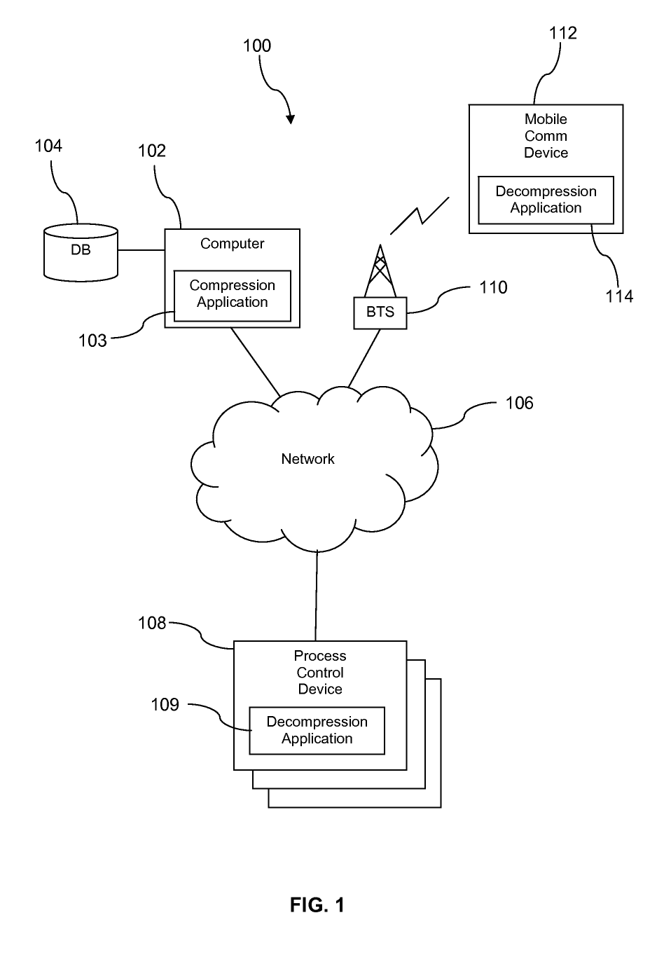

Turning now to FIG. 1, a system 100 is described. In an embodiment, the system 100 comprises a computer 102 that executes a compression application 103, an optional data store 104, a network 106, and one or more process control devices 108. An electronic file may be compressed by the compression application 103 executing on the computer 102 using a lossless compression algorithm that builds and uses a compression dictionary. To promote conciseness, hereinafter electronic files may be referred to simply as files. The original file may be retrieved by the computer 102 from the data store 104; the computer 102 may write the compressed file to the data store 104. The computer 102 may transmit the compressed file to one or more of the process control devices 108 via the network 106. A first decompression application 109 executing on the process control device 108 may then decompress the compressed file. In an embodiment, the reconstructed file may be firmware that is loaded and executed by a processor contained within the process control devices 108. Computers are discussed in more detail hereinafter. The network 106 may comprise any combination of private networks and/or public networks. In an embodiment, the network 106 may comprise a local area network in a manufacturing plant or other industrial facility and may not be connected to a larger network.

In an embodiment, the system 100 may comprise a mobile communication network including a base transceiver station (BTS) 110 that may provide wireless communication links to a mobile communication device 112. The computer 102 may transmit the compressed file to the mobile communication device 112 via the network 106 and the base transceiver station 110. A second decompression application 114 executing on the mobile communication device 112 may then decompress the compressed file. In an embodiment, the reconstructed file may be firmware that is loaded and executed by a processor contained within the mobile communication device 112. The mobile communication device 112 may comprise, but is not limited to, a mobile phone, a personal digital assistant (PDA), a media player, a portable computer, a laptop computer, a notebook computer, and other devices. It is understood that various embedded systems may comprise a wireless communication capability and may receive compressed files via the network 106 and a wireless access point (not shown) such as a WiFi hotspot or BLUETOOTH access point. These embedded systems may then decompress the compressed file, load firmware, and execute the firmware by a processor contained within the embedded system. The group of embedded systems is a large category of devices but may include printers, refrigerators, automobile head units, and other devices.

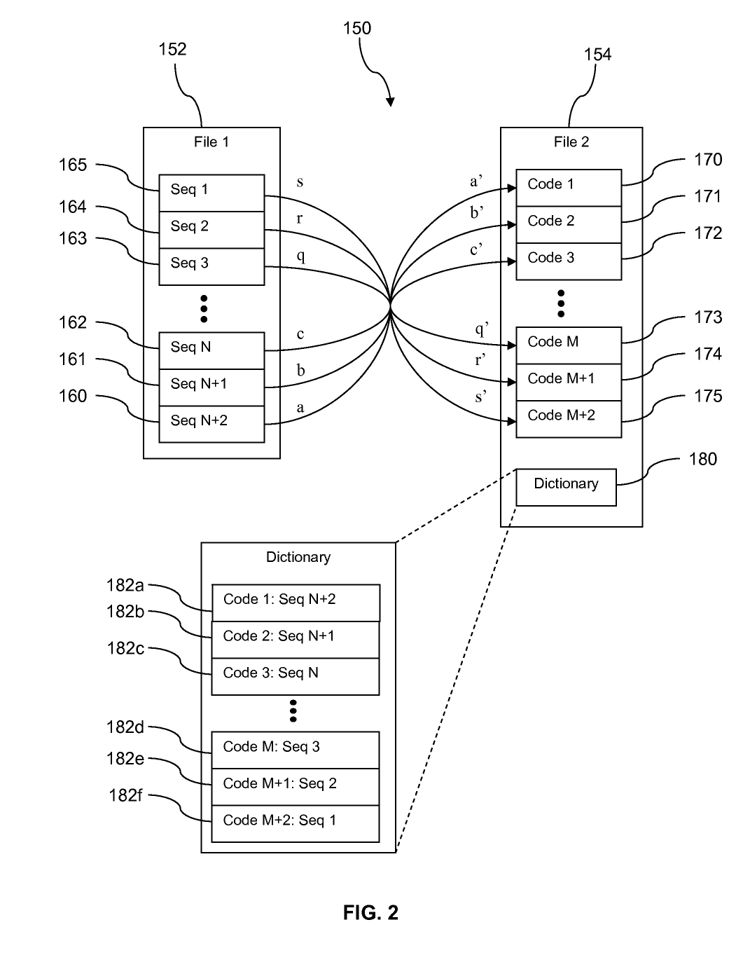

Turning now to FIG. 2, a compression process 150 is described. A first file 152 is an uncompressed file and a second file 154 is a compressed file created by the compression application 103 from the first file 152 using a lossless dictionary based compression algorithm. The first file 152 comprises a sequence of bytes that may be allocated to sequences, for example a first sequence 165, a second sequence 164, a third sequence 163, a fourth sequence 162, a fifth sequence 161, and a sixth sequence 160. The sequences 160-165 may comprise a single byte or a plurality of bytes. At least some of the sequences 160-165 comprise a plurality of bytes, for example a pattern of bytes that is observed to repeat in the first file 152. As an example, if the first file 152 comprises a list of names of graduating students, the sequence of bytes corresponding to ‘michael’ may be identified as such a pattern of bytes that repeats throughout the first file 152. The byte pattern ‘michael’ may be associated with a code comprising 12 bits of data, and where ‘michael’ occurs as seven bytes in the first file 152, it may be represented in compressed form by 1.5 bytes in the second file 154, thereby realizing a compression for this pattern of 78%. The association between the seven byte ‘michael’ and the 12 bit code may be stored as an entry in a compression dictionary 180.

The present disclosure teaches the compression application 103 scanning the first file 152 sequentially from bottom to top. Thus, the sixth sequence 160 is scanned first and may be written as a first code entry 170 in the second file 154. The fifth sequence 161 is scanned second and may be written as a second code entry 171 in the second file 154. The fourth sequence 162 is scanned third and may be written as a third code entry 172 in the second file 154. The third sequence 163 is scanned fourth and may be written as a fourth code entry 173 in the second file 154. The second sequence 164 is scanned fifth and may be written as a fifth code entry 174 in the second file 154. The first sequence 165 is scanned sixth and may be written as a sixth code entry 175 in the second file 154. The code entries 170-175 may be referred to as a compressed content portion of the second file 154. Note that information towards the top of the first file 152 is located towards the bottom of the second file 154 and information towards the bottom of the first file 152 is located towards the top of the second file 154. Thus, the order of information in the second file 154 is reversed with reference to the order of information in the first file 152.

As the compression application 103 scans the first file 152 from bottom to top, the compression application 103 identifies repeating patterns of bytes, associates a code with the pattern of bytes, and creates an association between the code and the pattern of bytes in the compression dictionary 180. In an embodiment, the code may be a small integer, for example an integer represented by 12 bits or some other number of bits. Alternatively, the compression application 103 may create an association between a pointer and the pattern of bytes, an association between a token and the pattern of bytes, or an association between an index and the pattern of bytes. Any shortened handle or abbreviation for use in referring to the longer pattern of bytes may be employed by the compression application 103 and/or for a corresponding decompression application. While hereinafter the description refers to the shortened handle as a code, it is understood any of these alternative kinds of handles may be used in the place of a code.

The association created in the compression dictionary 180 may be referred to as an entry 182 or a dictionary entry. The compression application 103 may build the compression dictionary 180 in a memory of the computer 102 as the compression proceeds and at the completion of writing the codes 170-175 into the second file 154, the compression application 103 writes the compression dictionary 180 itself into the second file 154, which may be referred to as a dictionary portion of the second file 154. The compression dictionary 180 may be written at the front of the second file 154 or at the back of the second file 154. Alternatively, the compression dictionary 180 may be written into an interior location of the second file 154.

In an embodiment, the compression dictionary 180 is predefined to have a limited size, for example a maximum number of entries. It is understood that, in an embodiment, the number of bytes per entry may be different. In an embodiment, the number of entries in the compression dictionary 180 may be established by the number of bits contained in the codes. For example, when codes composed of 12 bits are employed, the compression dictionary 180 may be limited to 4096 entries by the number of different codes that can be formed using 12 bits. It is expressly understood, however, that in different embodiments, the codes may contain a different number of bites. For example, in a first embodiment, all the codes may contain 12 bits; in a second embodiment, all the codes may contain 16 bits; in a third embodiment, all the codes may contain a different number of bits. Because different entries in the compression dictionary 180 may associate different length byte sequences to codes, different entries may comprise different numbers of bytes. As the compression application 103 scans and compresses the first file 152, the compression dictionary 180 may grow to its maximum size. Once at the maximum size, the compression application 103 no longer adds new entries to the compression dictionary 180. The compression application 103 may define a maximum number of bytes that may comprise a pattern, for example 10 bytes to 16 bytes. In other embodiments, however, the maximum number of bytes that may comprise a pattern may be more than 16 bytes or less than 10 bytes.

If a byte pattern repeats itself contiguously, the whole block of contiguously repeated byte patterns may be represented in the second file 154 as a code value and a number indicating a number of repetitions of the subject byte pattern. For example, if a 14 byte sequence of ‘0’ value bytes is identified and associated with code Ψ, and if 140 contiguous bytes all contain ‘0’ values, this block may be represented as an entry in the second file 154 that comprises the code Ψ and the number 10. In an embodiment, data in the first file 152 that does not match up to a byte pattern stored in the compression dictionary 180 may be stored “raw” or “as is”, for example uncompressed, in the second file 154.

It is thought that scanning the first file 152 from bottom to top when performing lossless compression based on building a limited size dictionary is not taught in the prior art. This unorthodox scanning sequence may provide advantages in some circumstances, for example when compressing files that have unevenly distributed byte patterns. As indicated above, firmware may sometimes be padded out to a predefined file size by appending default values at the bottom of the firmware file. As an example, if a firmware file is defined to comprise 10 megabytes but uses less than 7 megabytes for instructions and data, 3 megabytes may be assigned default values that comprise an extensive contiguously repeating byte pattern that can be efficiently compressed. If a fixed sized dictionary is used and the original file is scanned from top to bottom, the dictionary may be filled before reaching the portion of the firmware file comprising the contiguously repeating byte pattern at the end. Thus, the 3 megabytes of default values may be essentially uncompressed. A variety of more complicated compression algorithms are known that may accommodate this special case in a different way, for example scanning the first file 152 once to build the dictionary optimally and then scanning the first file 152 a second time to compress using the optimally built dictionary. In some applications, however, such more complicated compression algorithms may be undesirable.

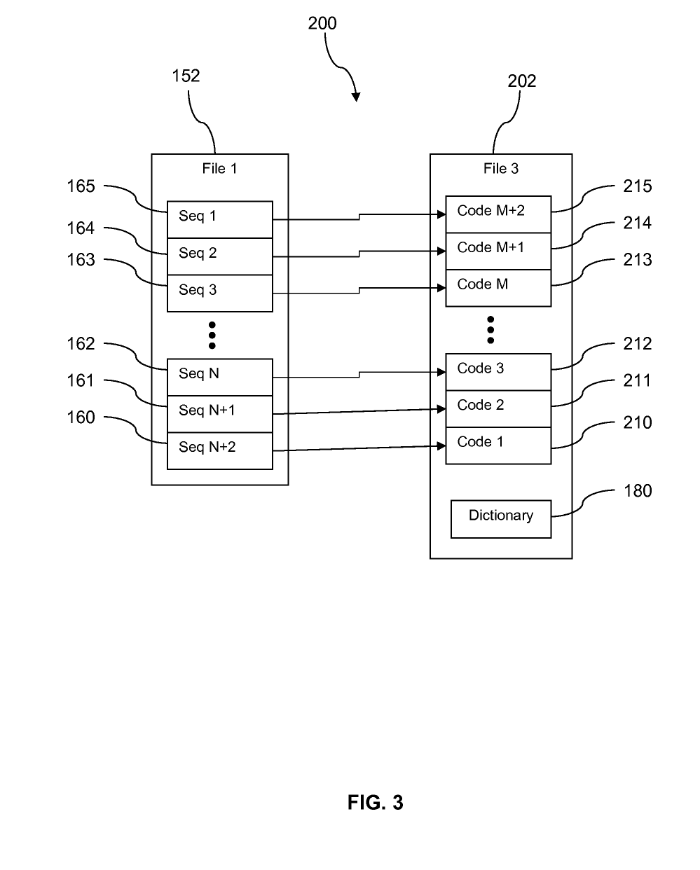

Turning now to FIG. 3, a compression process 200 is described. The first file 152 is compressed according to process 200 as a third file 202. As in process 150 described above, the first file 152 is scanned by the compression application 103 from bottom to top, but unlike the process 150, according to the process 200, the third file 202 is written from bottom to top. Thus, the sixth sequence 160 is scanned first and may be written as a twelfth code entry 210 in the third file 202. The fifth sequence 161 is scanned second and may be written as an eleventh code entry 211 in the third file 202. The fourth sequence 162 is scanned third and may be written as a tenth code entry 212 in the third file 202. The third sequence 163 is scanned fourth and may be written as a ninth code entry 213 in the third file 202. The second sequence 164 is scanned fifth and may be written as an eighth code entry 214 in the third file 202. The first sequence 165 is scanned sixth and may be written as a seventh code entry 215 in the third file 202. The code entries 210-215 may be referred to as a compressed content portion of the third file 202. Note that information towards the top of the first file 152 is located towards the top of the third file 202 and information towards the bottom of the first file 152 is located towards the bottom of the third file 202. Thus, the order of information in the third file 202 is generally in same order as the order of information in the first file 152. As with the process 150 above, the third file 202 further includes the dictionary 180 used to compress the first file 152.

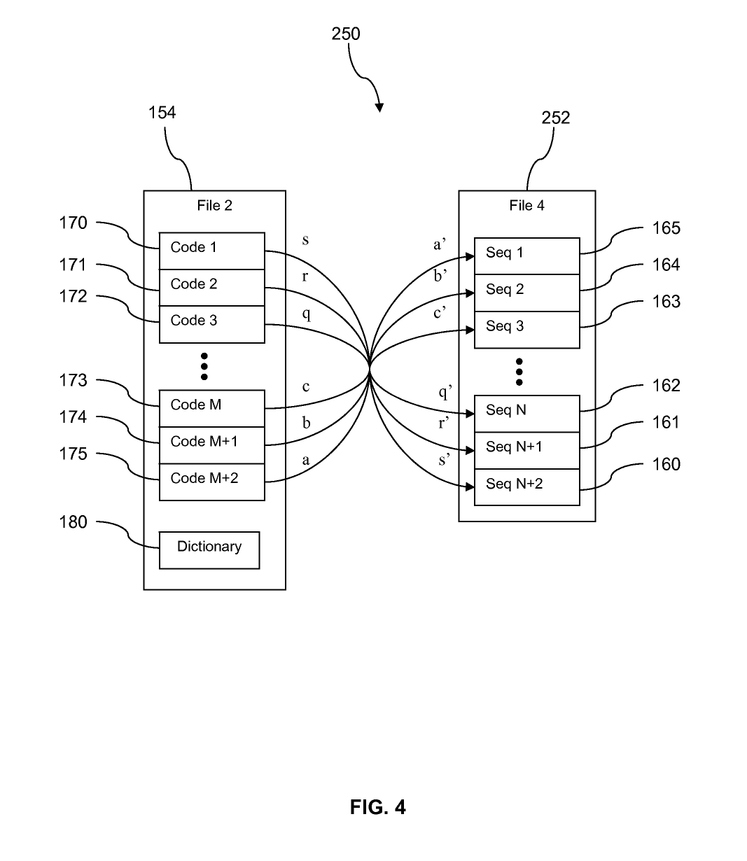

Turning now to FIG. 4, a decompression process 250 is described. In some contexts, decompressing may be referred to as extracting a file, for example extracting the first file 152 from the second file 154 or extracting the first file 152 from the third file 202. The process 250 is directed to decompressing the second file 154. Note that the sequence of information in the second file 154 is reversed with reference to the sequence of information in the first file 152, and hence the fourth file 252 decompressed from the second file 154 features information whose sequence is reversed with reference to the sequence of information in the second file 152—and therefore in the same sequence as the information in the first file 152. The decompression process 250 may be performed by the first decompression application 109 executing on the process control device 108 or by the second decompression application 114 executing on the mobile communication device 112.

The decompression application 109, 114 may scan the second file 154 from bottom to top and decompress each code entry 170-175 based on the associations between codes and byte sequences stored in the compression dictionary 180. Thus, the sixth code entry 175 is decompressed or extracted as the first sequence 165 based on the compression dictionary 180. The decompression application 109, 114 reads the sixth code entry 175 and then may search the compression dictionary 180 to find the code stored in the sixth code entry 175. When the subject code is found, the byte pattern is read from the compression dictionary 180. Optionally, the sixth code entry 175 may include a number indicating a number of times that the subject byte pattern is contiguously repeated. The decompression application 109, 114 then writes the byte pattern into the top of the fourth file 252 the appropriate number of times as the first sequence 165. Then the decompression application 109, 114 reads the fifth code entry 174 and decompresses it in a like manner and writes the second sequence 164 into the fourth file 252 below the first sequence 165. The remainder of the second file 154 is scanned in reverse order and decompressed in a similar fashion.

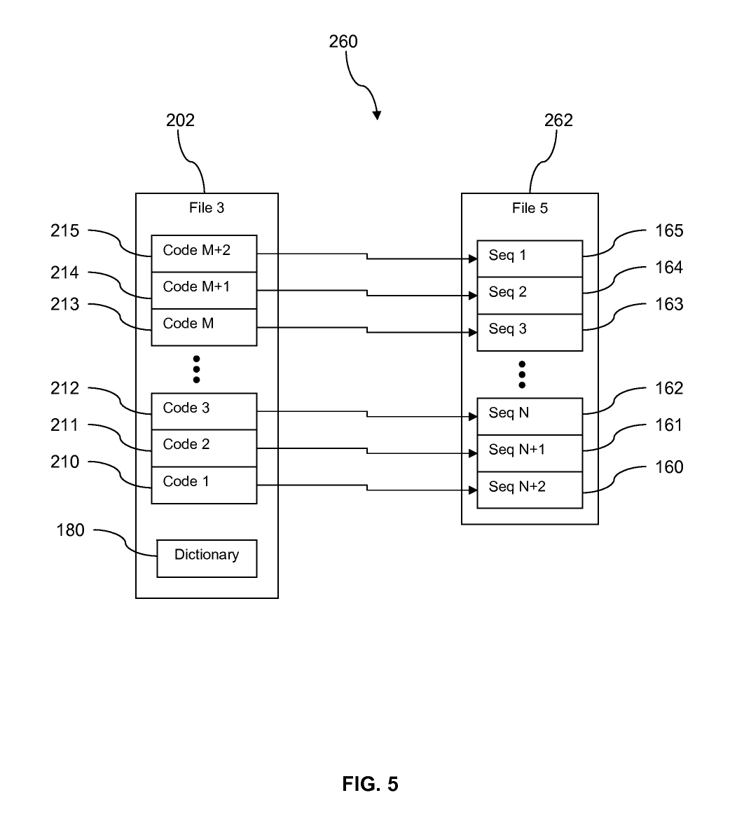

Turning now to FIG. 5, a decompression process 260 is described. The process 260 is used for decompressing the third file 202 described above with reference to FIG. 3. As noted in that description, the order of information in the third file 202 conforms to the order of information in the first file 152, although in a compressed form. As a result of this order agreement, the process 260 scans the third file 202 from top to bottom and writes the fifth file 262, the extraction of the first file 152, from top to bottom. The process 260 reads seventh code entry 215 and then may search the compression dictionary 180 to find the code stored in the seventh code entry 215. When the subject code is found, the byte pattern is read from the compression dictionary 180. Optionally, the seventh code entry 215 may include a number indicating a number of times that the subject byte pattern is contiguously repeated. The decompression application 109, 114 then writes the byte pattern into the top of the fifth file 262 the appropriate number of times as the first sequence 165. Then the decompression application 109, 114 reads the eighth code entry 214 and decompresses it in a like manner and writes the second sequence 164 into the fourth file 252 below the first sequence 165. The remainder of the third file 202 is scanned in reverse order and decompressed in a similar fashion.

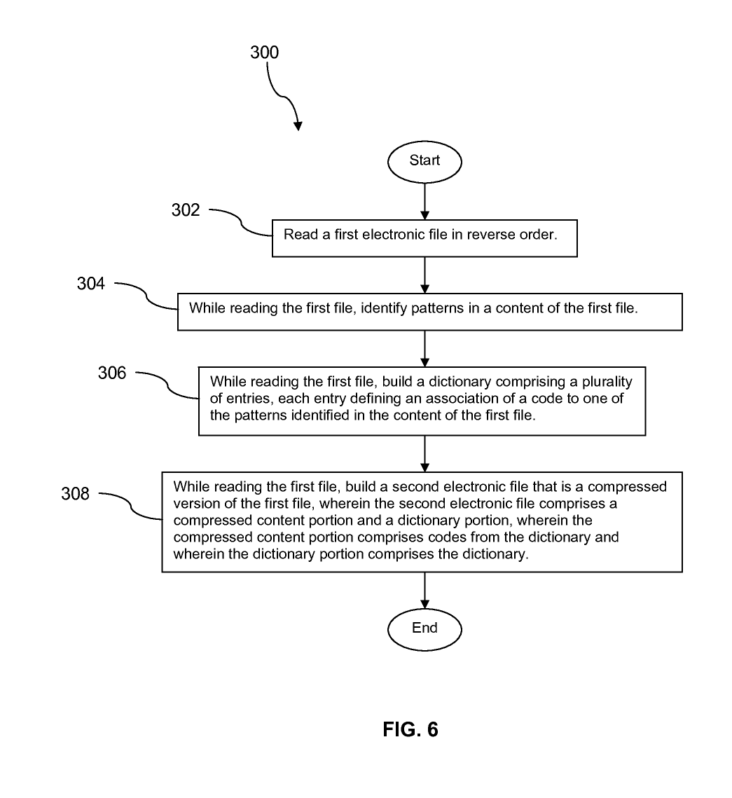

Turning now to FIG. 6, a method 300 is described. At block 302, a first electronic file is read in reverse order, from bottom to top, for example an original file to be compressed. At block 304, while reading the first electronic file, identify patterns in the content of the first file. For example, identify repeating sequences of bytes or other units of data. At block 306, while reading the first file, build a dictionary comprising a plurality of entries, each entry defining an association of a code to one of the patterns identified in the content of the first file. For example, build the compression dictionary 180 described above. The codes may have any structure or format, but in an embodiment, the codes may comprise 12 bits. At block 308, while reading the first file, build a second electronic file that is a compressed version of the first file, wherein the second electronic file comprises a compressed content portion and a dictionary portion, wherein the compressed content portion comprises codes from the dictionary and wherein the dictionary portion comprises the dictionary.

It is understood that the processing of blocks 302, 304, 306, and 308 may be performed concurrently. For example, a portion of the first file is read according to block 302; based on the portion of the first, identify a pattern of bytes according to block 304; optionally add an entry to the compression dictionary 180 based on the pattern of bytes according to block 306; and write a code entry into the second file according to block 308. Then another portion of the first file may be read according to block 302; and this iteration and/or cycling between process blocks may continue. The code entries may be written into the second file according to the process described with reference to FIG. 2 or according to the process described with reference to FIG. 3. In an embodiment, the method 300 may perform compression based at least in part on a Lempel-Ziv-Welch (LZW) compression algorithm.

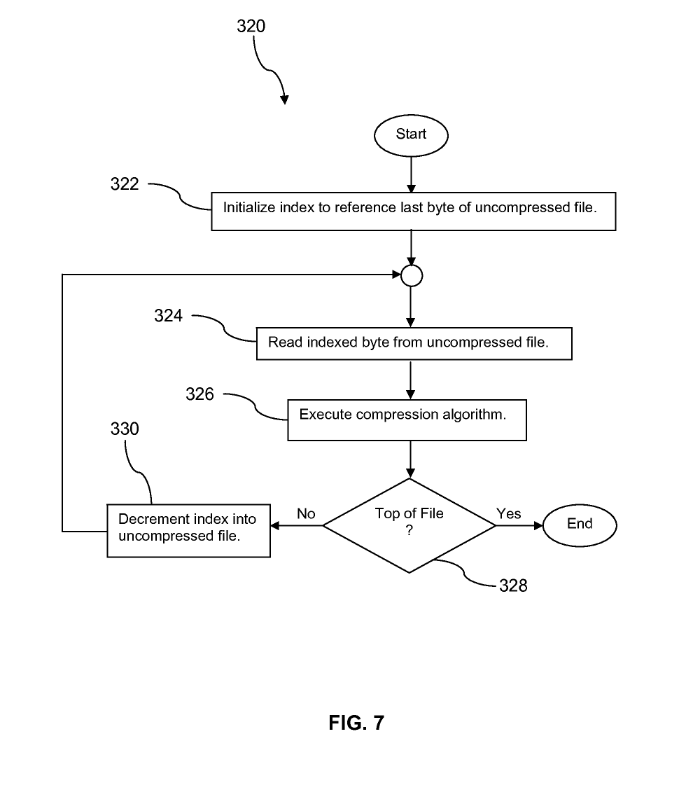

Turning now to FIG. 7, a process 320 is described. The process 320 provides a possible embodiment of the method 300 described above. It is understood that method 300 may be implemented in a wide variety of manners and that process 320 is described primarily to promote understanding the iterative aspect of the compression process. At block 322 an index is initialized to reference the last byte of an uncompressed file, for example the first file 152. At block 324, the byte referenced by the index is read from the uncompressed file. At block 326 a compression algorithm is executed based on the byte read in block 324. In an embodiment, the compression algorithm employed at block 326 may be based at least in part on a Lempel-Ziv-Welch (LZW) compression algorithm. In an embodiment, the compression algorithm may be implemented as a reusable component or as a library function that may be incorporated into or used by a wide variety of applications. Alternatively, the compression algorithm may be implemented and sold as commercial-off-the-shelf (COTS) software. The compression component may be stateful and may store the bytes that are fed to it. At block 328, if the top of the file to be compressed has been reached, the process 320 ends. If the top of the file has not been reached, the process proceeds to block 330. At block 330, the index is decremented to reference the preceding byte of the uncompressed file. Then block 324 is executed again. The process 320 cycles iteratively through blocks 324, 326, 328, and 330 until the top of the file is reached.

As bytes read from the uncompressed file are read and provided to the stateful compression algorithm in block 326, the compression algorithm identifies repeating patterns of bytes and both builds the compression dictionary 180 and writes into the compressed file, for example the second file 154 or the third file 202. It is understood that the compression algorithm may not write a code entry to the compressed file on every invocation. For example, the compression algorithm may accumulate bytes as they are read in a string and search the compression dictionary for entries that match the string. For example, the name ‘michael’ may be read as the sequence of bytes corresponding to ‘l’, ‘e’, ‘a’, ‘h’, ‘c’, ‘i’, and ‘m’, remembering that the uncompressed file is read in reverse order. As these bytes are read in the compression algorithm may search for matching entries. When the next character after ‘m’ is read, following reverse order, for example a byte corresponding to ‘z’, the compression algorithm may determine that there is no entry corresponding to the string ‘l’, ‘e’, ‘a’, ‘h’, ‘c’, ‘i’, ‘m’, and ‘z’, write the code associated with ‘michael’ into the compressed file, clear the accumulation string, and add ‘z’ to the string. Again, it is understood that a wide variety of implementations are contemplated by the present disclosure.

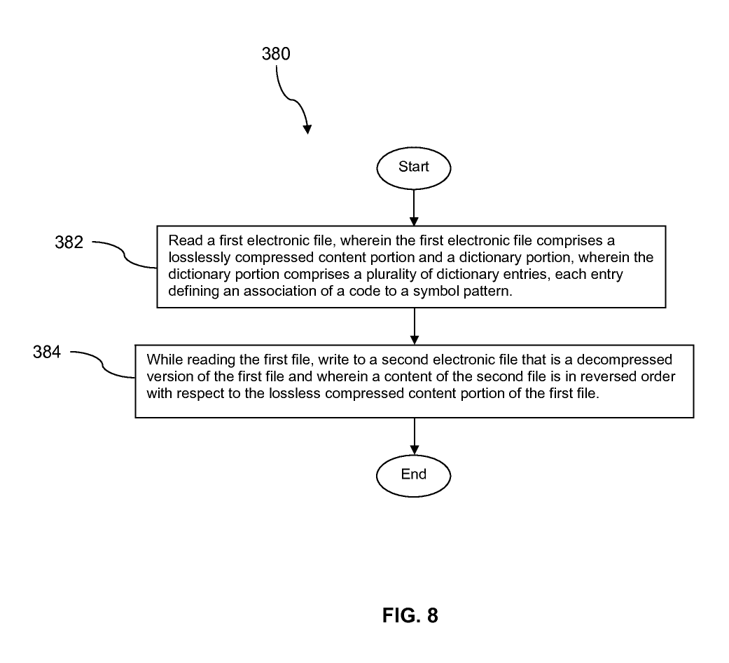

Turning now to FIG. 8, a method 380 is described. At block 382, a first electronic file is read, wherein the first electronic file comprises a losslessly compressed content portion and a dictionary portion, wherein the dictionary portion comprises a plurality of dictionary entries, each entry defining an association of a code to a symbol pattern. In an embodiment, the first electronic file was losslessly compressed based at least in part on a Lempel-Ziv-Welch (LZW) compression algorithm. At block 384, while reading the first file, write to a second electronic file that is a decompressed version of the first file and wherein a content of the second file is in reversed order with respect to the losslessly compressed content portion of the first file. For example, the second file 154 is read and the fourth file 252 is written to as described above with reference to FIG. 4

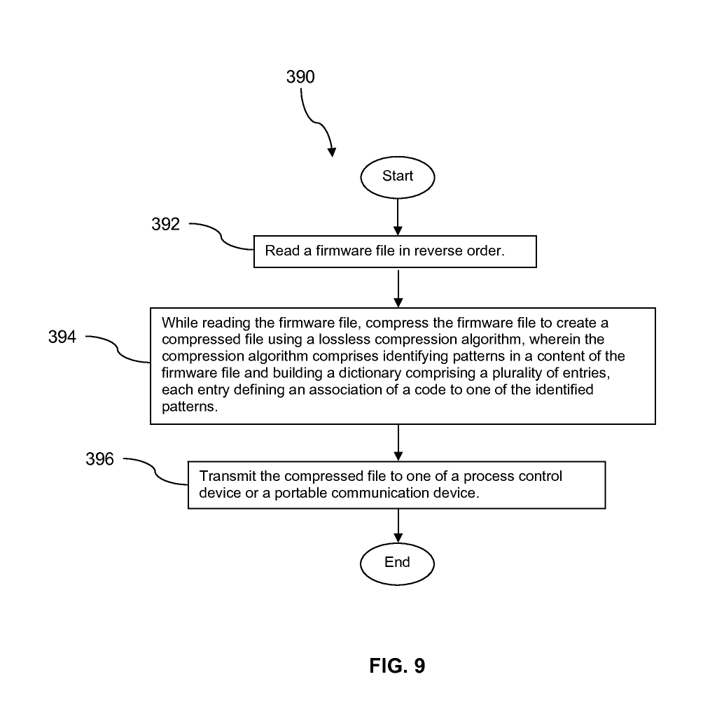

Turning now to FIG. 9, a method 390 is described. At block 392, a firmware file is read in reverse order. At block 394, while reading the firmware file, compress the firmware file to create a compressed file using a lossless compression algorithm, wherein the compression algorithm comprises identifying patterns in a content of the firmware file and building a dictionary comprising a plurality of entries, each entry defining an association of a code to one of the identified patterns. For example, the processing of blocks 392 and 394 are performed according to the process 150 described with reference to FIG. 2 or according to the process 200 described with reference to FIG. 3 above. In an embodiment, the method 390 may perform compression based at least in part on a Lempel-Ziv-Welch (LZW) compression algorithm. At block 396, the compressed file is transmitted to one of the process control devices 108 and/or to the mobile communication device 112. In an embodiment, the decompression application 109, 114 processes the compressed file to extract the firmware file. The firmware file may then be loaded and executed by the process control device 108 and/or mobile communication device 112.

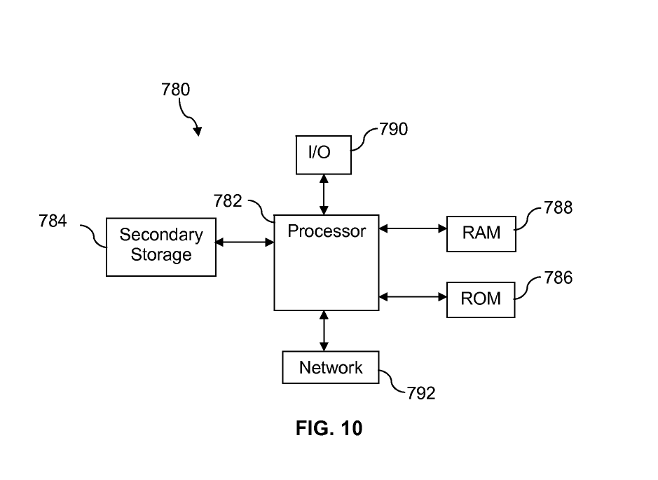

FIG. 10 illustrates a computer system 780 suitable for implementing one or more embodiments disclosed herein. The computer system 780 includes a processor 782 (which may be referred to as a central processor unit or CPU) that is in communication with memory devices including secondary storage 784, read only memory (ROM) 786, random access memory (RAM) 788, input/output (I/O) devices 790, and network connectivity devices 792. The processor 782 may be implemented as one or more CPU chips.

It is understood that by programming and/or loading executable instructions onto the computer system 780, at least one of the CPU 782, the RAM 788, and the ROM 786 are changed, transforming the computer system 780 in part into a particular machine or apparatus having the novel functionality taught by the present disclosure. It is fundamental to the electrical engineering and software engineering arts that functionality that can be implemented by loading executable software into a computer can be converted to a hardware implementation by well known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

The secondary storage 784 is typically comprised of one or more disk drives or tape drives and is used for non-volatile storage of data and as an over-flow data storage device if RAM 788 is not large enough to hold all working data. Secondary storage 784 may be used to store programs which are loaded into RAM 788 when such programs are selected for execution. The ROM 786 is used to store instructions and perhaps data which are read during program execution. ROM 786 is a non-volatile memory device which typically has a small memory capacity relative to the larger memory capacity of secondary storage 784. The RAM 788 is used to store volatile data and perhaps to store instructions. Access to both ROM 786 and RAM 788 is typically faster than to secondary storage 784. The secondary storage 784, the RAM 788, and/or the ROM 786 may be referred to in some contexts as computer readable storage media and/or non-transitory computer readable media.

I/O devices 790 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 792 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. These network connectivity devices 792 may enable the processor 782 to communicate with the Internet or one or more intranets. These network connectivity devices 792 may enable the processor 782 to communicate with process control networks, Fieldbus devices, highway addressable remote transducter (HART) protocol devices, and other process control devices and/or human machine interfaces (HMIs). With such a network connection, it is contemplated that the processor 782 might receive information from the network, or might output information to the network in the course of performing the above-described method steps. Such information, which is often represented as a sequence of instructions to be executed using processor 782, may be received from and outputted to the network, for example, in the form of a computer data signal embodied in a carrier wave.

Such information, which may include data or instructions to be executed using processor 782 for example, may be received from and outputted to the network, for example, in the form of a computer data baseband signal or signal embodied in a carrier wave. The baseband signal or signal embodied in the carrier wave generated by the network connectivity devices 792 may propagate in or on the surface of electrical conductors, in coaxial cables, in waveguides, in an optical conduit, for example an optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, may be generated according to several methods well known to one skilled in the art. The baseband signal and/or signal embedded in the carrier wave may be referred to in some contexts as a transitory signal.

The processor 782 executes instructions, codes, computer programs, scripts which it accesses from hard disk, floppy disk, optical disk (these various disk based systems may all be considered secondary storage 784), ROM 786, RAM 788, or the network connectivity devices 792. While only one processor 782 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 784, for example, hard drives, floppy disks, optical disks, and/or other device, the ROM 786, and/or the RAM 788 may be referred to in some contexts as non-transitory instructions and/or non-transitory information.

In an embodiment, the computer system 780 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 780 to provide the functionality of a number of servers that is not directly bound to the number of computers in the computer system 780. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 780, at least portions of the contents of the computer program product to the secondary storage 784, to the ROM 786, to the RAM 788, and/or to other non-volatile memory and volatile memory of the computer system 780. The processor 782 may process the executable instructions and/or data structures in part by directly accessing the computer program product, for example by reading from a CD-ROM disk inserted into a disk drive peripheral of the computer system 780. Alternatively, the processor 782 may process the executable instructions and/or data structures by remotely accessing the computer program product, for example by downloading the executable instructions and/or data structures from a remote server through the network connectivity devices 792. The computer program product may comprise instructions that promote the loading and/or copying of data, data structures, files, and/or executable instructions to the secondary storage 784, to the ROM 786, to the RAM 788, and/or to other non-volatile memory and volatile memory of the computer system 780.

In some contexts, a baseband signal and/or a signal embodied in a carrier wave may be referred to as a transitory signal. In some contexts, the secondary storage 784, the ROM 786, and the RAM 788 may be referred to as a non-transitory computer readable medium or a computer readable storage media. A dynamic RAM embodiment of the RAM 788, likewise, may be referred to as a non-transitory computer readable medium in that while the dynamic RAM receives electrical power and is operated in accordance with its design, for example during a period of time during which the computer 780 is turned on and operational, the dynamic RAM stores information that is written to it. Similarly, the processor 782 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method of compressing an electronic file, comprising:
reading a first electronic file in reverse order;
while reading the first file, identifying patterns in a content of the first file;
while reading the first file, building a dictionary comprising a plurality of entries, each entry defining an association of a code to one of the patterns identified in the content of the first file; and
while reading the first file, building a second electronic file that is a compressed version of the first file, wherein the second electronic file comprises a compressed content portion and a dictionary portion, wherein the compressed content portion comprises codes from the dictionary and wherein the dictionary portion comprises the dictionary.

2. The method of claim 1, wherein the second electronic file is a lossless compressed version of the first file.

3. The method of claim 2, wherein the first file is a firmware file that is targeted for execution by a process control device.

4. The method of claim 2, wherein the first file is a firmware file that is targeted for execution by a mobile communication device.

5. The method of claim 1, wherein building the second electronic file is performed using a Lempel-Ziv-Welch (LZW) compression algorithm.

6. The method of claim 1, wherein the dictionary is constrained to a predefined length.

7. A method of uncompressing an electronic file, comprising:
reading a first electronic file, wherein the first electronic file comprises a losslessly compressed content portion and a dictionary portion, wherein the dictionary portion comprises a plurality of dictionary entries, each entry defining an association of a code to a symbol pattern; and
while reading the first file, writing a second electronic file that is a decompressed version of the first file and wherein a content of the second file is in reversed order with respect to the lossless compressed content portion of the first file.

8. The method of claim 7, further comprising decompressing the first file while reading the first file.

9. The method of claim 8, wherein the first file is decompressed based on a Lempel-Ziv-Welch (LZW) compression algorithm.

10. The method of claim 8, wherein decompressing the first file is performed by a process control device.

11. The method of claim 8, wherein decompressing the first file is performed by a mobile communication device.

12. The method of claim 7, the first electronic file comprises code entries, the code entries comprising a 12-bit code.

13. The method of claim 7, wherein the first electronic file comprises code entries, the code entries comprising a code portion and a number representing the number of successive occurrences of a byte pattern in a portion of a file to be extracted from the first electronic file.

14. A computer program product for compressing an electronic file, the computer program product comprising:
a computer readable storage medium having a computer usable program code embodied therein,
the computer usable program code
to read the electronic file in reverse order and
while reading the electronic file, to compress the electronic file to create a compressed electronic file using a lossless compression algorithm, wherein the compression algorithm comprises identifying patterns in a content of the electronic file and building a dictionary comprising a plurality of entries, each entry defining an association of a code to one of the identified patterns.

15. The computer program product of claim 14, wherein the lossless compression algorithm is based on a Lempel-Ziv-Welch (LVW) compression algorithm.

16. The computer program product of claim 14, wherein the dictionary is limited to a predefined maximum size.

17. The computer program product of claim 16, wherein when the dictionary has been built out to maximum size, it is not changed any further during the remainder of the compression.

18. The computer program product of claim 14, the computer usable program code further to decompress the compressed file to create a decompressed file.

19. The computer program product of claim 14, wherein a code portion of the dictionary entries comprises a 12-bit value.

20. The computer program product of claim 14, the computer usable program code further to transmit the compressed electronic file to one of a process control device or a mobile communication device. gt
